(19) United States
(12) Patent Application Publication
(10) Pub. No.: US 2026/0044729 A1
(43) Pub. Date: Feb. 12, 2026

(54) EVALUATION AND MITIGATION OF SOFT-ERRORS IN PARALLEL AND DISTRIBUTED TRAINING AND INFERENCE OF TRANSFORMERS

(71) Applicant: Intel Corporation, Santa Clara, CA (US)

(72) Inventors: Yakai Wang, Shanghai (CN); Keqiang Wu, Shanghai (CN); Jian Zhang, Shanghai (CN)

(73) Assignee: Intel Corporation, Santa Clara, CA (US)

(21) Appl. No.: 18/995,667

(22) PCT Filed: Sep. 30, 2022
(86) PCT No.: PCT/CN2022/123553

§ 371 Date: Jan. 16, 2025

(51) Int. Cl. G06N 3/08; G06F 17/16; G06N 3/0455

(52) U.S. Cl. CPC G06N 3/08; G06F 17/16; G06N 3/0455

(57) ABSTRACT

The application provides an apparatus, method, and storage medium for evaluation and mitigation of soft-errors in parallel and distributed training and inference of transformers. The apparatus includes two or more processing units capable to communicate with each other and operating collectively as a transformer for deep learning. Each processing unit is configured to perform a matrix multiplication on a first matrix with a first column summation vector added after a last row of the first matrix and a first parameter matrix with a first row summation vector added after a last column of the first parameter matrix, to obtain a second matrix; perform an all-reduce operation on second matrices obtained by the two or more processing units to obtain a third matrix; and determine whether a soft error has occurred by performing a checksum verification on the third matrix.

### TECHNICAL FIELD

Embodiments described herein generally relate to deep learning technologies, and in particular, to an apparatus, method, and storage medium for evaluation and mitigation of soft-errors in parallel and distributed training and inference of transformers.

### BACKGROUND

With recent advances in deep learning, large models with billions of parameters have been proposed and demonstrated their incredible accuracy. For example, the popular Generative Pre-trained Transformer (GPT)-3 language model proposed by OpenAI consists of 175 billion parameters; and the powerful Megatron-LM from Nvidia and Microsoft employs 1,000 billion parameters. Training such large models is a daunting task, due to the unusually long training time even with thousands of state-of-the-art processing units, such as Graphics Processing Units (GPUs), Center Processing Units (CPUs), Field Programmable Gate Arrays (FPGAs), Application Specific Integrated Circuits (ASICs), and/or the like. In order to perform the training successfully within a reasonable amount of time, the efficiency and effectiveness of the training should be improved.

Model parallelism is one of classical approaches to deal with such challenges. Model parallelism means that two or more processing units perform the training task in parallel and layer parameters for the training are split among these processing units. By the model parallelism approach, each processing unit can multiply an input tensor by only a slice of layer parameters and aggregate outputs of all processing units to obtain an output tensor.

However, the model parallelism approach is not tolerant of soft errors. Soft errors often originate from environmental perturbation (e.g. radiation), voltage variations, material decay or impurity, etc. The soft errors usually manifest as bit flips, and are often ignored within integrated circuits (ICs) since they will disappear once the power is cycled. Though not as damaging as hard errors, soft errors can still cause serious consequences invisibly. For example, if a bit flip occurs in the most significant bit of a floating number, it will greatly change the value of this number. It can cause a neural network to suffer from problems such as incorrect computation results or predictions during inference and model loss non-drop during training.

Though the probability of a soft error for an individual component or operation is very low (at the 1e-8 level), it increases as the system gets larger and more distributed. For distributed training models with ˜1,000 billion of parameters, the probability of soft errors cannot be ignored, due to the large cluster size, frequent network communication and memory operations. A previous study “FT-ClipAct: Resilience Analysis of Deep Neural Networks and Improving their Fault Tolerance using Clipped Activation” by Hoang, L. H, et al. has shown that the classification accuracy drops with growing error rates in AlexNet under a single machine scenario. Things would get much worse in training and inference of transformers under the large-scale scenario.

### SUMMARY

According to an aspect of the disclosure, an apparatus is provided. The apparatus includes two or more processing units capable to communicate with each other and operating collectively as a transformer for deep learning, wherein each of the two or more processing units is configured to: perform a matrix multiplication on a first matrix with a first column summation vector added after a last row of the first matrix and a first parameter matrix with a first row summation vector added after a last column of the first parameter matrix, to obtain a second matrix, wherein each element of the first column summation vector is a sum of elements in a corresponding column of the first matrix, and each element of the first row summation vector is a sum of elements in a corresponding row of the first parameter matrix; perform an all-reduce operation on second matrices obtained by the two or more processing units to obtain a third matrix; and determine whether a soft error has occurred by performing a checksum verification on the third matrix.

According to another aspect of the disclosure, a method is provided. The method includes: performing, by each of two or more processing units operating collectively as a transformer for deep learning, a matrix multiplication on a first matrix with a first column summation vector added after a last row of the first matrix and a first parameter matrix with a first row summation vector added after a last column of the first parameter matrix, to obtain a second matrix, wherein each element of the first column summation vector is a sum of elements in a corresponding column of the first matrix, and each element of the first row summation vector is a sum of elements in a corresponding row of the first parameter matrix; performing, by each of the two or more processing units, an all-reduce operation on second matrices obtained by the two or more processing units to obtain a third matrix; and determining, by each of the two or more processing units, whether a soft error has occurred by performing a checksum verification on the third matrix.

Another aspect of the disclosure provides a machine readable storage medium having instructions stored thereon, which when executed by a machine cause the machine to perform the above method.

Another aspect of the disclosure provides a computing device including means for implementing the above method.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a schematic diagram of principles of the algorithm-based fault-tolerant matrix multiplication;

FIG. 2 shows an overview of a system for model parallelism of a transformer according to some embodiments of the disclosure;

FIG. 3 shows an example of model parallelism in Megatron-LM;

FIG. 4 shows another example of model parallelism in Megatron-LM;

FIG. 5 shows a flowchart of a process for evaluation and mitigation of soft-errors in parallel and distributed training and inference of transformers, according to some embodiments of the disclosure;

FIG. 6 shows a flowchart of a process for checksum verification on a third matrix mentioned in FIG. 5;

FIG. 7 is a block diagram illustrating components, according to some example embodiments, able to read instructions from a machine-readable or computer-readable medium and perform any one or more of the methodologies discussed herein; and

FIG. 8 is a block diagram of an example processor platform in accordance with some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).” The ordinal numbers, such as “first”, “second” and “third” etc., as used herein, are only for purpose of distinguishing items after them, and not to mean an actual order of the items.

Several approaches have been proposed to detect and correct soft errors.

For example, Error Correction Codes (ECCs) can be used to detect and seamlessly correct errors in Random Access Memories (RAMs) but at a cost of reduced speed and higher on-chip errors. A research has shown that the ECCs can reduce the chance of having a bit error in a 4 GigaBytes (GBs) of RAM to about one chance in six billions. However, this may not be sufficient for large-scale distributed scenarios with TeraByte (TB) memory, ˜1000 billions parameters, and weeks of training time. Moreover, the ECCs help little when errors occur outside the memory.

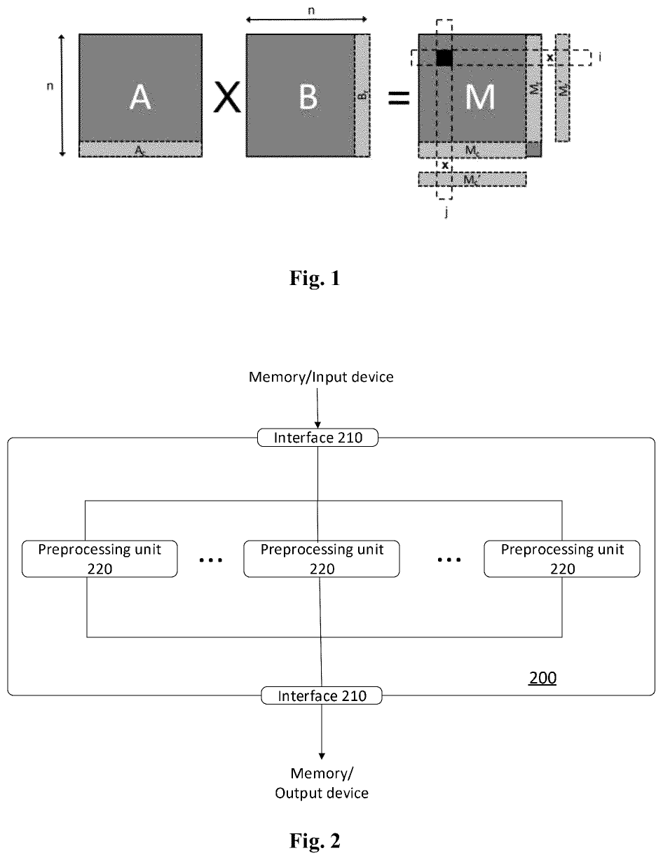

Another approach to address soft errors is an algorithm-based fault-tolerant calculation. The original algorithm-based fault-tolerant matrix multiplication introduces partial sums for checking. It exploits the properties of linear algebra. FIG. 1 shows a schematic diagram of principles of the algorithm-based fault-tolerant matrix multiplication (see e.g., Fernando Fernandes dos Santos et al., “Evaluation and Mitigation of Soft-Errors in Neural Network-Based Object Detection in Three GPU Architectures”, the 47^{th} Annual Institute of Electrical and Electronic Engineers (IEEE)/International Federation for Information Processing (IFIP) International Conference on Dependable Systems and Networks Workshops (DSN-W), pages 169-176 (2017), which is incorporated herewith in its entirety for all propose). As shown, the matrix multiplication is performed on a matrix A and a matrix B to obtain a matrix M. In order to detect and correct soft errors, a row checksum vector A_{c} is added after the last row of the matrix A, and a column checksum vector Bᵣ is added after the last column of the matrix B. Each element of the row checksum vector A_{c} is a sum of elements in a corresponding column of the matrix A, and thus the row checksum vector A_{c} can also be referred to as a column summation vector. Similarly, each element of the column checksum vector Bᵣ is a sum of elements in a corresponding row of the matrix B, as such, the column checksum vector Bᵣ can also be referred to as a row summation vector. The matrix multiplication of the matrix A with the row checksum vector A_{c} added and the matrix B with the column checksum vector Bᵣ added generate the matrix M with a row checksum vector M_{c} and column checksum vector Mᵣ added.

In order to check whether a soft error has occurred, a row vector M_{c}′ is generated by that each element is a sum of all elements of a corresponding column in the matrix M, and a column vector Mᵣ′ is generated by that each element is a sum of all elements of a corresponding row in the matrix M. It is checked by element whether the row vector M_{c}′ is equal to the row checksum vector M_{c} (i.e., whether a difference between them is zero) and whether the column vector Mᵣ′ is equal to the column checksum vector Mᵣ (i.e., whether a difference between them is zero). If the row vector M_{c}′ is equal to the row checksum vector M, and the column vector Mᵣ′ is equal to the column checksum vector Mᵣ, it can be determined that no soft error has occurred, or otherwise, it can be determined that at least one soft error has occurred.

Particularly, when at least one soft error has occurred, it can be determined where the soft error has occurred. For example, it can be determined that at least one soft error has occurred in an i^{th} row of the matrix M when the i^{th} element (denoted as Mᵣ′[i]) of the column vector Mᵣ′ is not equal to the i^{th} element (denoted as Mᵣ[i]) of the column checksum vector Mᵣ, or similarly, it can be determined that at least one soft error has occurred in a j^{th} column of the matrix M when the j^{th} element (denoted as M_{c}′[j]) of the row vector M_{c}′ is not equal to the j^{th} element (denoted as M_{c}[j]) of the row checksum vector M_{c}, where i and j are positive integers. As a result, an error element M[i, j] can be determined. At this case, the error element M[i, j] can be corrected quickly using the row or column checksum vectors by following equation (1):

$${M}_{correct} [ i , j ] = M [ i , j ] - ( {M}_{r}^{′} [ i ] - {M}_{r} [ i ] ) = M [ i , j ] - ( {M}_{c}^{′} [ j ] - {M}_{c} [ j ] ) \qquad ( 1 )$$

However, the original algorithm is only capable to protect matrix multiplication operations on a single machine. When an error occurs in communication, memory storage or transportation (which are frequent in distributed training and inference scenarios), the original algorithm loses its protection ability.

In model parallelism scenarios, communication, memory storage or transportation among different processing units may happen frequently, and soft errors may occur during these processes. It is critical to detect and resolve the potential soft errors as early as possible. Embodiments of the present application provide an apparatus, method, and storage medium for evaluation and mitigation of soft-errors in parallel and distributed training and inference of transformers, and achieve optimal fault tolerance and performance for the parallel and distributed training and inference of transformers. The apparatus, method, and storage medium for evaluation and mitigation of soft-errors in parallel and distributed training and inference of transformers provided herein can detect and resolve potential soft errors during communication, memory storage or transportation among different nodes. Hardware ECCs or parity supports are not required. In addition, it provides flexibility for users to selectively enable fault tolerance for specific layers so as to achieve optimal balance between fault tolerance and performance.

FIG. 2 shows an overview of a system 200 for model parallelism of a transformer according to some embodiments of the disclosure.

The number, capability, and/or capacity of elements of system 200 may vary, depending on whether system 200 is used as a stationary computing device (e.g., a server computer in a data center, a workstation, a desktop computer, etc.) or a mobile computing device (e.g., a smartphone, tablet computing device, laptop computer, game console, Internet of Things (IoT) device, etc.). In various implementations, the system 100 may include one or more components of a data center, a desktop computer, a workstation, a laptop, a smartphone, a tablet, a digital camera, a smart appliance, a smart home hub, a network appliance, and/or any other device/system that processes data.

As a simplified situation, the system 200 includes input/output (I/O) interface(s) 210 and two or more processing units 220.

The I/O interface(s) 210 may be configured to receive input data for deep learning operations and/or configuration data of the transformer from a memory/storage device or input device and output an outcome of the deep learning operations to a memory/storage device or output device.

In some embodiments, one or more memories/storage devices may be included in the system 200 or may be coupled to the system 200. The memories/storage devices may include main memories, disk storage, or any suitable combination thereof. The memories/storage devices may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

In some embodiments, various I/O devices may be present within or connected to the system 200 via the I/O interface(s) 210. The input devices may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output devices may be included to show information or otherwise convey information, such as sensor readings, actuator position(s), or other like information. Data and/or graphics may be displayed on the out devices. The output devices may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the system 200. The output devices may also include speakers and/or other audio emitting devices, printer(s), and/or the like. Additionally or alternatively, sensor(s) may be used as the input devices (e.g., an image capture device, motion capture device, or the like) and one or more actuators may be used as the output devices (e.g., an actuator to provide haptic feedback or the like).

The configuration data of the transformer may be used to configure the two or more processing units 220 to operate collectively as the transformer. The two or more processing units 220 may include any kinds of components that have processing or computing capabilities, such as GPUs and CPUs (which may be collectively referred to as “XPUs”), FPGAs, ASICs, and/or the like.

Generally, one of the two or more processing units 220 may take the role a primary processing unit/node to implement the configuration of the two or more processing units 220 to achieve the function of the transformer. For example, the primary processing unit/node can split layer parameters of the transformer among the two or more processing units 120.

After configuration, the two or more processing units 220 can perform operations on input operators as configured in parallel.

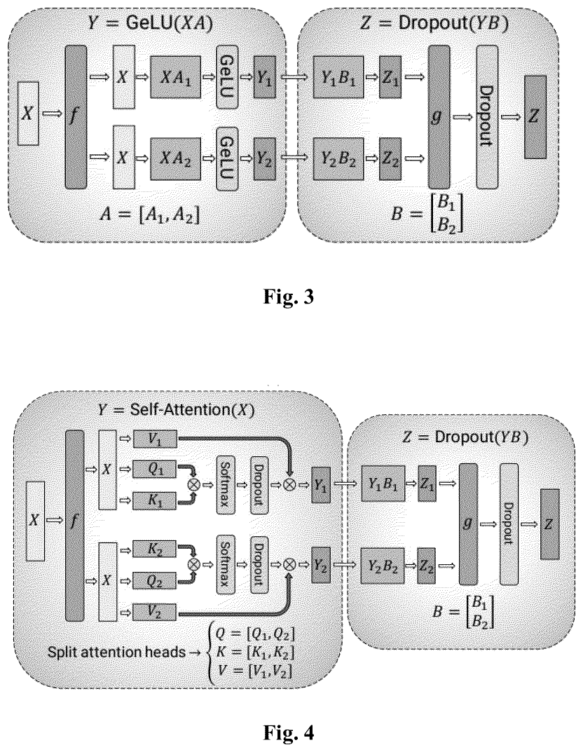

Just for simplicity of description, Megatron-LM is used as an example to introduce operations of the transformer, which should not be explained as a limitation to principles of the disclosure. FIG. 3 and FIG. 4, as provided below, refer to “Efficient large-scale language model training on GPU clusters using megatron-LM” by Deepak Narayanan et al., in SC' 21: The International Conference for High Performance Computing, Networking, Storage and Analysis, St. Louis, Missouri, USA, pages 58:1-58:15 (Nov. 14-19, 2021) to illustrate model parallelism in Megatron-LM, which is incorporated herewith in its entirety for all purpose, for example, to act as an basis for the inventive concepts of the present application.

FIG. 3 shows an example of model parallelism in Megatron-LM. In this example, model parallelism is applied in a multi-layer perceptron (MLP) layer. The MLP layer is a simple layer composed of two consecutive matrix multiplications Y=GeLU(XA) and Z=Dropout(YA). GeLU(⋅) is an activation function that applied to each matrix element. This activation function can be approximated as GeLU(x)≈xσ(1.702x), where σ(⋅) is the normal distribution function. It is used in GPT-3, BERT and most other transformers. Dropout(⋅) is a regularization technique in a training process that drops some elements of a matrix with a given possibility.

The two multiplications can be performed on, for example, two processing units, in the following steps:
3.1) Layer parameters are received as configuration data, which may be expressed as parameter matrices A and B. the parameter matrices A and B are split, for example, by the primary processing unit, into two slices

$$A = [ {A}_{1} , {A}_{2} ] , B = [ \begin{matrix}{B}_{1} \\ {B}_{2}\end{matrix} ] .$$

A first processing unit owns layer parameters A₁, B₁, while a second processing unit owns layer parameters A₂, B₂.
3.2) The first processing unit and the second processing unit receive an input tensor X, and do partial matrix multiplications in parallel. The first processing unit calculates XA₁, then Y₁B₁; and the second processing unit calculates XA₂, then Y₂B₂. In this process the two processing units do their work independently and no communication is involved in this step.
3.3) An all-reduce operation g is applied so that each processing unit possesses the same output tensor Z=Z₁+Z₂. The tensor Z can be fed to a next layer as the input tensor X.

The Dropout operation as shown is for purpose of mitigation of over-fitting, which is not to be discussed in the disclosure.

The above three steps repeat so as to calculate consecutive MLPs. This scheme can be utilized in all kinds of training and inference of transformers.

FIG. 4 shows another example of model parallelism in Megatron-LM. In this example, inherent parallelism in a multi-head attention operation is exploited to partition a self-attention block. The key (K), query (Q), and value (V) matrices can be partitioned in a column-parallel fashion. The output linear layer can then directly operate on the partitioned output of the attention operation (weight matrix partitioned across rows). This approach splits the matrix multiplication into the MLP and self-attention blocks across the processing units (such as, GPUs) while requiring only two all-reduce operations in the forward pass (g operator) and two all-reduces in the backward pass (f operator). f and g are conjugate. f is the identity operator in the forward pass and all reduce in the backward pass, while g is the reverse.

Similarly as in FIG. 3, the multiplications of FIG. 4 can be performed on, for example, two processing units, in the following steps:
4.1) Layer parameters are received as configuration data, which may be expressed as parameter matrices (K, Q, V) and B. The parameter matrices (K, Q, V) and B are split, for example, by the primary processing unit, into two slices

$$( K = [ {K}_{1} , {K}_{2} ] , Q = [ {Q}_{1} , {Q}_{2} ] , V = [ {V}_{1} , {V}_{2} ] ) , B = [ \begin{matrix}{B}_{1} \\ {B}_{2}\end{matrix} ] .$$

A first processing unit owns layer parameters (K₁, Q₁, V₁), B₁, while a second processing unit owns layer parameters (K₂, Q₂, V₂), B₂.
4.2) The first processing unit and the second processing unit receive an input tensor X, and do partial matrix multiplications in parallel. The first processing unit calculates (XK₁, XQ₁, XV₁), and the second processing unit calculates (XK₂, XQ₂, XV₂). In this process the two processing units do their work independently and no communication is involved in this step.
4.3) The first processing unit does matrix multiplication softmax[(XQ₁)(XK₁)^{T}] and further multiplies the outcome with XV₁ to obtain Y₁, the second processing unit does matrix multiplication softmax[(XQ₂)(XK₂)^{T}] and further multiplies the outcome with XV₂ to obtain Y₂, in parallel. In this process the two processing units do their work independently and no communication is involved in this step.
4.4) The first processing unit and the second processing unit calculate Y₁B₁ and Y₂B₂ in parallel. An all-reduce operation g is applied so that each processing unit possesses the same output tensor Z=Z₁+Z₂. The tensor Z can be fed to a next layer as the input tensor X.

The Dropout operation as shown is for purpose of mitigation of over-fitting, which is not to be discussed in the disclosure.

Just for purpose of illustration, the approach for evaluation and mitigation of soft-errors in parallel and distributed training and inference of transformers provided herein will be described in connection with the Model parallelism scheme in Megatron-LM of FIG. 4. It should be noted that the principles of the present application can be applied to any model parallelism scenarios where communication, memory storage or transportation among different processing units may happen, and the details of the operations of the Megatron-LM as shown in FIG. 4 should be used to limit the protection scope of the present application.

Both steps 4.2) and 4.3) involve matrix multiplications. As mentioned, in steps 4.2) and 4.3), the two processing units do their work independently and no communication is involved. Therefore, the original algorithm-based fault-tolerance for matrix multiplication described with reference to FIG. 1 can be applied to these steps to detect and correct soft errors.

For example, in step 4.2), a row checksum vector can be added after the last row of the input tensor X, and a column checksum vector can be added after the last column of each parameter matrix Kᵢ, Qᵢ, Vᵢ. A checksum verification is performed on each output of the matrix multiplications XK₁, XQ₁, XV₁, XK₂, XQ₂, XV₂, using the algorithm described with reference to FIG. 1, which will not be repeated here.

Step 4.4) involves matrix multiplications Y₁B₁ and Y₂B₂ performed respectively on the two processing units, and the all-reduce operation g performed on each processing unit to generate the same output tensor Z=Z₁+Z₂. In order to enable each processing unit to perform the all-reduce operation g, the two processing units must communicate with each other. There is a possibility for a soft error to occur during the communication. As mentioned, the original algorithm-based fault-tolerance for matrix multiplication described with reference to FIG. 1 cannot detect the soft error to occur during the communication.

The following approach is proposed to check and correct such soft error. The first processing unit can add a first column summation vector (i.e., a first row checksum column summation vector) after the last row of the matrix Y₁ and add a first row summation vector (i.e., a first column checksum vector) after the last column of the parameter matrix B₁, perform a matrix multiplication on the matrix Y₁ with the first column summation vector added and the parameter matrix B₁ with the first row summation vector added, to obtain Z₁ with two checksum vectors added (which can be referred to as Z₁′). Each element of the first column summation vector is a sum of elements in a corresponding column of the matrix Y₁, and each element of the first row summation vector is a sum of elements in a corresponding row of the parameter matrix B₁. In parallel to the operations of the first processing unit, the second processing unit can add a second column summation vector (i.e., a second row checksum column summation vector) after the last row of the matrix Y₂ and add a second row summation vector (i.e., a second column checksum vector) after the last column of the parameter matrix B₂, perform a matrix multiplication on the matrix Y₂ with the second column summation vector added and the parameter matrix B₂ with the second row summation vector added, to obtain Z₂ with two checksum vectors added (which can be referred to as Z₂′). Each element of the second column summation vector is a sum of elements in a corresponding column of the matrix Y₂, and each element of the second row summation vector is a sum of elements in a corresponding row of the parameter matrix B₂.

After that, the first processing unit and the second processing unit communicate with each other, enabling each processing unit to know the matrices Z′ and Z₂′. Each processing unit performs an all-reduce operation on matrices Z₁′ and Z₂′ to obtain a output tensor Z′=Z′+Z₂′, and determines whether a soft error has occurred by performing a checksum verification on the tensor Z′.

Because Z′=Z₁′+Z₂′, the sums of row or column checksum vectors of Z′ and Z₂′ directly forms the row or column checksum vectors of Z′.

Similarly as the checksum verification described with reference to FIG. 1, the checksum verification on the tensor Z′ may include a first verification of whether a first difference between an element in the last row of the tensor Z′ and a sum of elements in a corresponding column of the tensor Z is zero, and a second verification of whether a second difference between an element in the last column of the tensor Z′ and a sum of elements in a corresponding row of the tensor Z is zero.

Each processing unit performs the two verifications on the tensor Z′, and determines that that no soft error has occurred if both the first verification and the second verification are passed, i.e., the first difference between any element in the last row of the tensor Z′ and a sum of elements in a corresponding column of the tensor Z is zero, and the second difference between any element in the last column of the tensor Z′ and a sum of elements in a corresponding row of the tensor Z is also zero.

If any one or two of the first verification and the second verification is not passed, the processing unit determines that at least one soft error has occurred. Particularly, it can be determined that at least one soft error has occurred in an i^{th} row of the tensor Z′(or Z), if the first difference between an element in the i^{th} row and the last column of the tensor Z′ and a sum of elements in the i^{th} row of the tensor Z is not zero, or similarly, it can be determined that at least one soft error has occurred in a j^{th} column of the tensor Z′(or Z), if the second difference between an element in the j^{th} column and the last row of the tensor Z′ and a sum of elements in the j^{th} column of the tensor Z is not zero, where i and j are positive integers. As a result, an error element Z[i, j] can be determined. At this case, the error element Z[i, j] can be corrected quickly by adding the first difference or the second difference to the error element Z[i, j].

For the particular example as described in FIG. 4, the matrix Y₁ and matrix Y₂ are obtained from the preceding steps, in which checksum verifications mag have been performed, as such, the matrix Y₁ and matrix Y₂ themselves may have row and column checksum vectors included therein. In this case, the first processing unit would not add the first column summation vector after the last row of the matrix Y₁, but would omit a last column of the matrix obtained from the last step to obtain the matrix Y₁ with the first column summation vector added, and the second processing unit would not add the second column summation vector after the last row of the matrix Y₂, but would omit a last column of the matrix obtained from the last step to obtain the matrix Y₂ with the second column summation vector added.

The checksum verification on the tensor Z′ can provide additional protection on communication, memory storage and transportation for the parallel and distributed training and inference of transformers. The approaches provided herein can protect the calculation performed not only on a single machine, but also network transmission and memory copy due to the all-reduce operation, so as to protect the whole process of single layer processing of transformers.

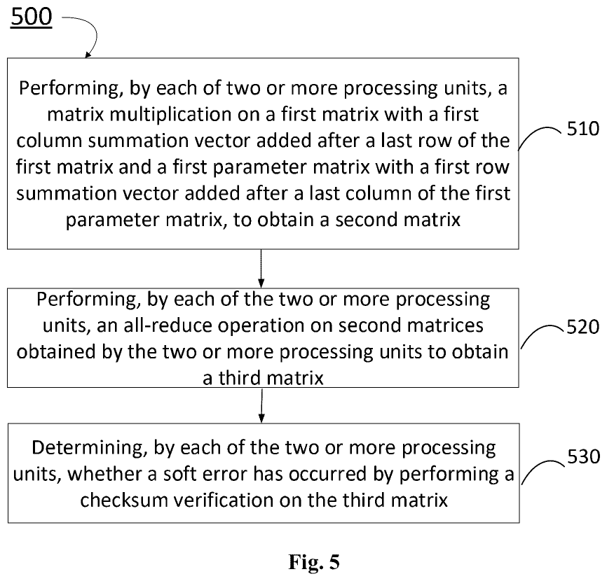

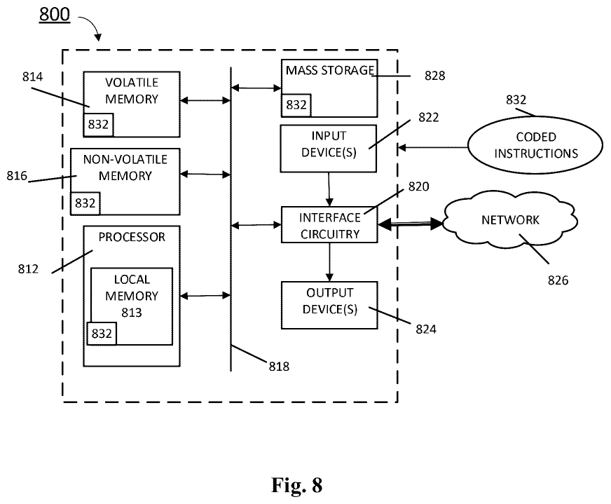

FIG. 5 shows a flowchart of a process 500 for evaluation and mitigation of soft-errors in parallel and distributed training and inference of transformers, according to some embodiments of the disclosure. The process 500 may be implemented, for example, by the system 100 of FIG. 1, or by one or more processors of any computing device. An example of the processors is to be shown in FIG. 8.

As shown in FIG. 5, the process 500 includes, at block 510, performing, by each of two or more processing units, a matrix multiplication on a first matrix with a first column summation vector added after a last row of the first matrix and a first parameter matrix with a first row summation vector added after a last column of the first parameter matrix, to obtain a second matrix. Each element of the first column summation vector is a sum of elements in a corresponding column of the first matrix, and each element of the first row summation vector is a sum of elements in a corresponding row of the first parameter matrix.

The process 500 includes, at block 520, performing, by each of the two or more processing units, an all-reduce operation on second matrices obtained by the two or more processing units to obtain a third matrix.

The process 500 includes, at block 530, determining, by each of the two or more processing units, whether a soft error has occurred by performing a checksum verification on the third matrix. The checksum verification on the third matrix may include. a first verification of whether a first difference between an element in a last row of the third matrix and a sum of elements in a corresponding column except the element in the last row of the third matrix is zero; and a second verification of whether a second difference between an element in a last column of the third matrix and a sum of elements in a corresponding row except the element in the last column of the third matrix is zero.

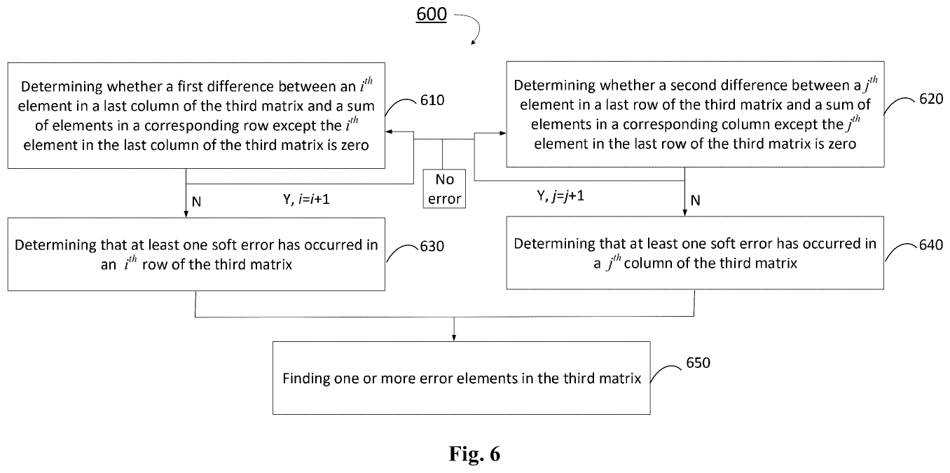

FIG. 6 shows a flowchart of a process 600 for checksum verification on the third matrix mentioned in FIG. 5. The process 600 may be implemented, for example, by the system 100 of FIG. 1, or by one or more processors of any computing device. An example of the processors is to be shown in FIG. 8.

The process 600 may include at block 610, determining whether a first difference between an i^{th} element in a last column of the third matrix and a sum of elements in a corresponding row except the i^{th} element in the last column of the third matrix is zero. i is an positive integer and is not greater than a number of rows of the third matrix. If Yes, the process 600 may cycle with the block 610 to check the next element in the last column of the third matrix, until all elements in the last column of the third matrix have been checked. If No, the process 600 may proceed to block 630 to determining that at least one soft error has occurred in an i^{th} row of the third matrix.

The process 600 may include at block 620, determining whether a second difference between a j^{th} element in a last row of the third matrix and a sum of elements in a corresponding column except the j^{th} element in the last row of the third matrix is zero. j is an positive integer and is not greater than a number of columns of the third matrix. If Yes, the process 600 may cycle with the block 620 to check the next element in the last row of the third matrix, until all elements in the last row of the third matrix have been checked. If No, the process 600 may proceed to block 640 to determining that at least one soft error has occurred in a j^{th} column of the third matrix.

After determining that at least one soft error has occurred in the i^{th} row of the third matrix at block 630 and determining that at least one soft error has occurred in the j^{th} column of the third matrix at block 640, the process 600 may proceed to block 650 to find one or more error elements in the third matrix.

After all elements in the last row and the last column of the third matrix have been checked and the first differences and the second differences are all zero, the process 600 can determine that no error has occurred.

It should be noted that blocks 610 and 630 and blocks 620 and 640 can be performed in parallel or sequentially, which will not be limited herein.

More particularly, the process 500 of FIG. 5 and the process 600 of FIG. 6 may be implemented in one or more modules as a set of logic instructions stored in a machine-readable or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the process 500 of FIG. 5 and the process 600 of FIG. 6 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

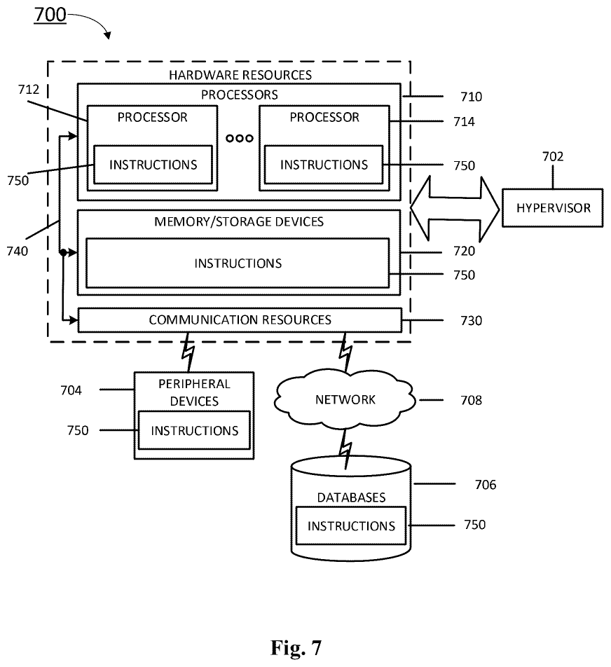

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714 which may be, e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof.

The memory/storage devices 720 may include main memory, disk storage, or any suitable combination thereof. The memory/storage devices 720 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 730 may include interconnection or network interface components or other suitable devices to communicate with one or more peripheral devices 704 or one or more databases 706 via a network 708. For example, the communication resources 730 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

FIG. 8 is a block diagram of an example processor platform in accordance with some embodiments of the disclosure. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes interface circuitry 820. The interface circuitry 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuitry 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 820 of the illustrated example, thus, typically includes a graphics driver card, a graphics driver chip and/or a graphics driver processor.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 820 may include a training dataset inputted through the input device(s) 822 or retrieved from the network 826.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

Machine executable instructions 832 may be stored in the mass storage device 828, in the volatile memory 814, in the non-volatile memory 816, and/or on a removable non-transitory computer readable storage medium such as a CD or DVD.

The following paragraphs describe examples of various embodiments.

Example 1 includes an apparatus, comprising: two or more processing units capable to communicate with each other and operating collectively as a transformer for deep learning, wherein each of the two or more processing units is configured to: perform a matrix multiplication on a first matrix with a first column summation vector added after a last row of the first matrix and a first parameter matrix with a first row summation vector added after a last column of the first parameter matrix, to obtain a second matrix, wherein each element of the first column summation vector is a sum of elements in a corresponding column of the first matrix, and each element of the first row summation vector is a sum of elements in a corresponding row of the first parameter matrix; perform an all-reduce operation on second matrices obtained by the two or more processing units to obtain a third matrix; and determine whether a soft error has occurred by performing a checksum verification on the third matrix.

Example 2 includes the apparatus of Example 1, wherein the checksum verification on the third matrix comprises: a first verification of whether a first difference between an element in a last row of the third matrix and a sum of elements in a corresponding column except the element in the last row of the third matrix is zero; and a second verification of whether a second difference between an element in a last column of the third matrix and a sum of elements in a corresponding row except the element in the last column of the third matrix is zero.

Example 3 includes the apparatus of Example 2, wherein each of the two or more processing units is configured to determine that that no soft error has occurred under a condition that both the first verification and the second verification are passed.

Example 4 includes the apparatus of Example 2, wherein each of the two or more processing units is configured to determine that at least one soft error has occurred under a condition that at least one of the first verification and the second verification is not passed.

Example 5 includes the apparatus of Example 4, wherein each of the two or more processing units is configured to: determine that at least one soft error has occurred in an i^{th} row of the third matrix under a condition that the first difference between an element in the i^{th} row and the last column of the third matrix and a sum of elements in the i^{th} row except the element in the last column of the third matrix is not zero, wherein i is a positive integer; and generate a new value for an error element in the i^{th} column of the third matrix by adding the first difference to the error element.

Example 6 includes the apparatus of Example 4, wherein each of the two or more processing units is configured to: determine that at least one soft error has occurred in an j^{th} column of the third matrix under a condition that the second difference between an element in the j^{th} column and the last row of the third matrix and a sum of elements in the j^{th} column except the element in the last row of the third matrix is not zero, wherein j is a positive integer; and generate a new value for an error element in the j^{th} row of the third matrix by adding the second difference to the error element.

Example 7 includes the apparatus of any of Examples 1-6, wherein each of the two or more processing units is configured to: receive an input tensor; add a second column summation vector after a last row the input tensor and a second row summation vector after a last column of the second parameter matrix, wherein each element of the second column summation vector is a sum of elements in a corresponding column of the input tensor, and each element of the second row summation vector is a sum of elements in a corresponding row of the second parameter matrix; perform a matrix multiplication on the input tensor with the second column summation vector added and the second parameter matrix with the second row summation vector added, to obtain a fourth matrix; and check whether a soft error has occurred by performing a checksum verification on the fourth matrix.

Example 8 includes the apparatus of Example 7, wherein the first matrix with the first column summation vector added is obtained by omitting a last column of the fourth matrix from the fourth matrix.

Example 9 includes the apparatus of Example 7, wherein one of the two or more processing units is a primary processing unit, and is configured to split layer parameters of the transformer for deep learning among the two or more processing units, to generate corresponding two or more first parameter matrices and corresponding two or more second parameter matrices.

Example 10 includes the apparatus of Example 9, wherein the corresponding two or more second parameter matrices comprise parameters of a self-attention layer in the transformer for deep learning, and the corresponding two or more first parameter matrices comprise parameters of a dropout layer in the transformer for deep learning.

Example 11 includes the apparatus of any of Examples 1-10, wherein the two or more units comprise Graphics Processing Units (GPUs), Center Processing Units (CPUs), Field Programmable Gate Arrays (FPGAs), or Application Specific Integrated Circuits (ASICs).

Example 12 includes a method, comprising: performing, by each of two or more processing units operating collectively as a transformer for deep learning, a matrix multiplication on a first matrix with a first column summation vector added after a last row of the first matrix and a first parameter matrix with a first row summation vector added after a last column of the first parameter matrix, to obtain a second matrix, wherein each element of the first column summation vector is a sum of elements in a corresponding column of the first matrix, and each element of the first row summation vector is a sum of elements in a corresponding row of the first parameter matrix; performing, by each of the two or more processing units, an all-reduce operation on second matrices obtained by the two or more processing units to obtain a third matrix; and determining, by each of the two or more processing units, whether a soft error has occurred by performing a checksum verification on the third matrix.

Example 13 includes the method of Example 12, wherein the checksum verification on the third matrix comprises:
a first verification of whether a first difference between an element in a last row of the third matrix and a sum of elements in a corresponding column except the element in the last row of the third matrix is zero; and
a second verification of whether a second difference between an element in a last column of the third matrix and a sum of elements in a corresponding row except the element in the last column of the third matrix is zero.

Example 14 includes the method of Example 13, further comprising determining, by each of the two or more processing units, that that no soft error has occurred under a condition that both the first verification and the second verification are passed.

Example 15 includes the method of Example 13, further comprising determining, by each of the two or more processing units, that at least one soft error has occurred under a condition that at least one of the first verification and the second verification is not passed.

Example 16 includes the method of Example 15, further comprising: determining, by each of the two or more processing units, that at least one soft error has occurred in an i^{th} row of the third matrix under a condition that the first difference between an element in the i^{th} row and the last column of the third matrix and a sum of elements in the i^{th} row except the element in the last column of the third matrix is not zero, wherein i is a positive integer; and generating, by each of the two or more processing units, a new value for an error element in the i^{th} column of the third matrix by adding the first difference to the error element.

Example 17 includes the method of any of Example 15, further comprising: determining, by each of the two or more processing units, that at least one soft error has occurred in an j^{th} column of the third matrix under a condition that the second difference between an element in the j^{th} column and the last row of the third matrix and a sum of elements in the j^{th} column except the element in the last row of the third matrix is not zero, wherein j is a positive integer; and generating, by each of the two or more processing units, a new value for an error element in the j^{th} row of the third matrix by adding the second difference to the error element.

Example 18 includes the method of any of Examples 12-17, further comprising: receiving, by each of the two or more processing units, an input tensor; adding, by each of the two or more processing units, a second column summation vector after a last row the input tensor and a second row summation vector after a last column of the second parameter matrix, wherein each element of the second column summation vector is a sum of elements in a corresponding column of the input tensor, and each element of the second row summation vector is a sum of elements in a corresponding row of the second parameter matrix; performing, by each of the two or more processing units, a matrix multiplication on the input tensor with the second column summation vector added and the second parameter matrix with the second row summation vector added, to obtain a fourth matrix; and checking, by each of the two or more processing units, whether a soft error has occurred by performing a checksum verification on the fourth matrix.

Example 19 includes the method of Example 18, wherein the first matrix with the first column summation vector added is obtained by omitting a last column of the fourth matrix from the fourth matrix.

Example 20 includes the method of Example 18, wherein one of the two or more processing units is a primary processing unit, and the method further comprises splitting, by the primary processing unit, layer parameters of the transformer for deep learning among the two or more processing units, to generate corresponding two or more first parameter matrices and corresponding two or more second parameter matrices.

Example 21 includes the method of Example 20, wherein the corresponding two or more second parameter matrices comprise parameters of a self-attention layer in the transformer for deep learning, and the corresponding two or more first parameter matrices comprise parameters of a dropout layer in the transformer for deep learning.

Example 22 includes the method of any of Examples 12-21, wherein the two or more units comprise Graphics Processing Units (GPUs), Center Processing Units (CPUs), or Field Programmable Gate Arrays (FPGAs), or Application Specific Integrated Circuits (ASICs).

Example 23 includes a machine readable storage medium having instructions stored thereon, the instructions when executed by a machine, causing the machine to perform the method of any of Examples 11 to 22.

Example 24 includes a computing device, comprising means for performing the method of any of Examples 11 to 22.

Example 25 includes an apparatus comprising one or more processors to implement the one or more of the processes as shown and described in the description.

Example 26 includes a method comprising one or more of processes as shown and described in the description.

Example 27 includes a system comprising one or more memories to store computer-readable instructions for implementing one or more of the processes as shown and described in the description.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. The disclosure is intended to cover any adaptations or variations of the embodiments discussed herein. Therefore, it is manifestly intended that embodiments described herein be limited only by the appended claims and the equivalents thereof.

1-24. (canceled)

25. An apparatus comprising:
memory;
instructions;
two or more processor circuits to be programmed based on the instructions to communicate with each other and operate collectively as a transformer for deep learning, wherein each of the two or more processor circuits is to:
perform a matrix multiplication on a first matrix with a first column summation vector added after a last row of the first matrix and a first parameter matrix with a first row summation vector added after a last column of the first parameter matrix, to obtain a second matrix, wherein each element of the first column summation vector is a sum of elements in a corresponding column of the first matrix, and each element of the first row summation vector is a sum of elements in a corresponding row of the first parameter matrix;
perform an all-reduce operation on second matrices obtained by the two or more processor circuits to obtain a third matrix; and
determine whether a soft error has occurred based on a checksum verification performed on the third matrix.

26. The apparatus of claim 25, wherein the checksum verification on the third matrix includes:
a first verification of whether a first difference between an element in a last row of the third matrix and a sum of elements in a corresponding column except the element in the last row of the third matrix is zero; and
a second verification of whether a second difference between an element in a last column of the third matrix and a sum of elements in a corresponding row except the element in the last column of the third matrix is zero.

27. The apparatus of claim 26, wherein each of the two or more processor circuits is to determine that that no soft error has occurred under a condition that both the first verification and the second verification are passed.

28. The apparatus of claim 26, wherein each of the two or more processor circuits is configured to determine that at least one soft error has occurred under a condition that at least one of the first verification and the second verification is not passed.

29. The apparatus of claim 28, wherein each of the two or more processor circuits is to:
determine that at least one soft error has occurred in an i^{th} row of the third matrix under a condition that the first difference between an element in the i^{th} row and the last column of the third matrix and a sum of elements in the it row except the element in the last column of the third matrix is not zero, wherein i is a positive integer; and
generate a new value for an error element in an it column of the third matrix by adding the first difference to the error element.

30. The apparatus of claim 28, wherein each of the two or more processor circuits is to:
determine that at least one soft error has occurred in a j^{th} column of the third matrix under a condition that the second difference between an element in the j^{th} column and the last row of the third matrix and a sum of elements in the j^{th} column except the element in the last row of the third matrix is not zero, wherein j^{th} is a positive integer; and
generate a new value for an error element in a j^{th} row of the third matrix by adding the second difference to the error element.

31. The apparatus of claim 25, wherein each of the two or more processor circuits is to:
receive an input tensor;
add a second column summation vector after a last row the input tensor and a second row summation vector after a last column of a second parameter matrix, wherein each element of the second column summation vector is a sum of elements in a corresponding column of the input tensor, and each element of the second row summation vector is a sum of elements in a corresponding row of the second parameter matrix;
perform a matrix multiplication on the input tensor with the second column summation vector added and the second parameter matrix with the second row summation vector added, to obtain a fourth matrix; and
check whether a soft error has occurred by performing a checksum verification on the fourth matrix.

32. The apparatus of claim 31, wherein the first matrix with the first column summation vector added is obtained by omitting a last column of the fourth matrix from the fourth matrix.

33. The apparatus of claim 31, wherein one of the two or more processor circuits is a primary processor circuit, and the primary processor circuit is to split layer parameters of the transformer for deep learning among the two or more processor circuits, to generate corresponding two or more first parameter matrices and corresponding two or more second parameter matrices.

34. The apparatus of claim 33, wherein the corresponding two or more second parameter matrices include parameters of a self-attention layer in the transformer for deep learning, and the corresponding two or more first parameter matrices include parameters of a dropout layer in the transformer for deep learning.

35. The apparatus of any claim 25, wherein the two or more processor circuits include Graphics Processing Units (GPUs), Center Processing Units (CPUs), Field Programmable Gate Arrays (FPGAs), or Application Specific Integrated Circuits (ASICs).

36. A method comprising:
performing, by each of two or more processor circuits operating collectively as a transformer for deep learning, a matrix multiplication on a first matrix with a first column summation vector added after a last row of the first matrix and a first parameter matrix with a first row summation vector added after a last column of the first parameter matrix, to obtain a second matrix, wherein each element of the first column summation vector is a sum of elements in a corresponding column of the first matrix, and each element of the first row summation vector is a sum of elements in a corresponding row of the first parameter matrix;
performing, by each of the two or more processor circuits, an all-reduce operation on second matrices obtained by the two or more processor circuits to obtain a third matrix; and
determining, by each of the two or more processor circuits, whether a soft error has occurred based on a checksum verification performed on the third matrix.

37. The method of claim 36, wherein the checksum verification on the third matrix includes:
a first verification of whether a first difference between an element in a last row of the third matrix and a sum of elements in a corresponding column except the element in the last row of the third matrix is zero; and
a second verification of whether a second difference between an element in a last column of the third matrix and a sum of elements in a corresponding row except the element in the last column of the third matrix is zero.

38. The method of claim 37, including determining, by each of the two or more processor circuits, that that no soft error has occurred under a condition that both the first verification and the second verification are passed.

39. The method of claim 37, including determining, by each of the two or more processor circuits, that at least one soft error has occurred under a condition that at least one of the first verification and the second verification is not passed.

40. A non-transitory machine readable storage medium comprising instructions to cause two or more processor circuits that operate collectively as a transformer for deep learning to at least:
perform a matrix multiplication on a first matrix with a first column summation vector added after a last row of the first matrix and a first parameter matrix with a first row summation vector added after a last column of the first parameter matrix, to obtain a second matrix, wherein each element of the first column summation vector is a sum of elements in a corresponding column of the first matrix, and each element of the first row summation vector is a sum of elements in a corresponding row of the first parameter matrix;
perform an all-reduce operation on second matrices obtained by the two or more processor circuits to obtain a third matrix; and
determine whether a soft error has occurred based on a checksum verification performed on the third matrix.

41. The machine readable storage medium of claim 40, wherein the checksum verification on the third matrix includes:
a first verification of whether a first difference between an element in a last row of the third matrix and a sum of elements in a corresponding column except the element in the last row of the third matrix is zero; and
a second verification of whether a second difference between an element in a last column of the third matrix and a sum of elements in a corresponding row except the element in the last column of the third matrix is zero.

42. The machine readable storage medium of claim 41, wherein the instructions are to cause each of the two or more processor circuits to determine that that no soft error has occurred under a condition that both the first verification and the second verification are passed.

43. The machine readable storage medium of claim 41, wherein the instructions are to cause each of the two or more processor circuits to determine that at least one soft error has occurred under a condition that at least one of the first verification and the second verification is not passed.

44. The machine readable storage medium of claim 40, wherein the instructions are to cause each of the two or more processor circuits to:
receive an input tensor;
add a second column summation vector after a last row the input tensor and a second row summation vector after a last column of a second parameter matrix, wherein each element of the second column summation vector is a sum of elements in a corresponding column of the input tensor, and each element of the second row summation vector is a sum of elements in a corresponding row of the second parameter matrix;
perform a matrix multiplication on the input tensor with the second column summation vector added and the second parameter matrix with the second row summation vector added, to obtain a fourth matrix; and
check whether a soft error has occurred based on a checksum verification performed on the fourth matrix.
